(19) United States
(12) Patent Application Publication
(10) Pub. No.: US 2004/0135118 A1
(43) Pub. Date: Jul. 15, 2004

(54) Process for producing a liquid crystalline polymer

(76) Inventor: Marion G. Waggoner, Landenberg, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/726,119

(22) Filed: Dec. 2, 2003

Related U.S. Application Data
(60) Provisional application No. 60/434,360, filed on Dec. 18, 2002.

(51) Int. Cl. C09K 19/38; C09K 19/32; C09K 19/12; C09K 19/20

(52) U.S. Cl. 252/299.01; 252/299.62; 252/299.66; 252/299.67

(57) ABSTRACT

Liquid crystalline polymers (LCP) with relatively high melting points are prepared by a process which includes solid state polymerization of a (pre)polymer, which contains alkali metal cations, to raise the LCP molecular weight. The presence of the alkali metal cations in the (pre)polymer usually results in a final polymer with less color and/or a higher melting point. The LCPs are useful as molding resins and for films.

### CROSS-REFERENCE TO RELATED APPLICATION

This application claims the benefit of U.S. Provisional Application No. 60/434,360, filed Dec. 18, 2002.

### FIELD OF THE INVENTION

A liquid crystalline polymer (LCP) is produced by an improved process using solid state polymerization at elevated temperatures in which a small amount of alkali metal cation present in the LCP results in an LCP with less color.

### BACKGROUND OF THE INVENTION

LCPs are useful in many applications, for examples as molding resins and in films. A typical process for producing LCPs involves mixing selected diols and dicarboxylic acids and/or hydroxycarboxylic acids with enough of a carboxylic acid anhydride such as acetic anhydride to acylate the hydroxyl groups of the diols and/or hydroxycarboxylic acids present, and then heating the resulting mixture to remove byproduct carboxylic acid. The mixture is eventually heated to a relatively high temperature, typically in latter stages under vacuum, to produce the final LCP. This is done while the process mixture is a liquid (in the melt). However if the melting point of the final desired LCP is very high, it may be difficult to heat the mixture to such a high temperature (above the melting point), and/or the polymer may slowly thermally decompose at that temperature. In such a situation, before the polymer is fully formed (the molecular weight has reached the desired level) the liquid is cooled and solidified, and broken into small particles. These particles are then heated while in the “solid state” under stream of inert gas such as nitrogen or under a vacuum to raise the molecular weight to the desired level. This latter part of the process is commonly known as solid state polymerization (SSP), see for instance F. Pilati in G. Allen, et al., Ed., Comprehensive Polymer Science, Vol. 5, Pergamon Press, Oxford, 19189, Chapter 13, which is hereby included by reference.

Even when using SSP, if done at high temperatures and/or for long periods, some signs of degradation may be apparent. A usually sensitive indicator of degradation of organic materials in general, including LCPs, is darkening (color formation) in materials that when pure are colorless (colorless herein includes white when caused by light scattering). A typical progression of color degradation would be colorless or white to light yellow to dark yellow or tan, light brown, dark brown and then black. Coloration of LCPs in many instances is not desired, for example it may give the impression of a lower quality polymer, or it may be impossible to color the polymer with a dye or pigment to a desired color shade. Therefore polymerization processes, both melt polymerization and SSP processes which produce LCPs with reduced color, are desirable.

Japanese Patent Application 96041187A describes the production of a polymer made from 4,4-biphenol, terephthalic acid, 2,6-naphthalenedicarboxylic acid, and 4-hydroxybenzoic acid using (in part) SSP. No mention is made of an alkali metal being present or of color formation in general.

### SUMMARY OF THE INVENTION

This invention concerns, a process for the production of a polyester or poly(ester-amide) liquid crystalline polymer, comprising a step of increasing the molecular weight of said liquid crystalline polymer by solid state polymerizing said liquid crystalline polymer at a temperature of about 300° C. or more, and wherein the liquid crystalline polymer after said solid state polymerizing of said liquid crystalline polymer has a melting point of about 380° C. or more, wherein the improvement comprises, about 5 to about 1000 ppm of an alkali metal cation is present in said liquid crystalline polymer during said solid state polymerizing.

### DETAILS OF THE INVENTION

Herein a process for forming an LCP by SSP is described. Typically the lower molecular weight LCP, which is the starting material for the SSP, is made in the melt. As noted above SSP is a well known process of raising the molecular weight of an already formed polymer (sometimes called a prepolymer) by heating the (pre)polymer in the solid state, usually in the form of small particles, while removing volatiles, typically volatile polymerization byproducts, during the process. The volatiles may be removed by doing the SSP under vacuum, or by passing an inert gas through a bed of the particles to carry off volatiles (the inert gas may be recycled back through the process after removal of the volatiles from the gas). The temperature of the SSP is kept below the melting and/or softening temperatures of the particles so the particles do not coalesce together. All of the processes for making polyester and poly(ester-amide) LCPs are amenable to raising the molecular weight of the LCP by a SSP.

Preferably the LCP is made from a carboxylate ester of the hydroxyl groups on diols and hydroxycarboxylic acids. These esters may be formed before the polymerization process is begun, or may be formed in situ by adding a carboxylic anhydride to the monomers in the first stage of the polymerization, as described above. A preferred carboxylic anhydride is acetic anhydride, which forms acetate esters. In another variation of this polymerization process, aryl esters (such as phenyl esters) are formed between the carboxyl groups of the monomers and added aryl hydroxyl compounds, and these esters are reacted with the monomers containing hydroxyl groups, while distilling off an aromatic hydroxyl compound such as phenol (hydroxybenzene).

In the present process 5 to 1000 ppm of an alkali metal cation is present in the LCP. Not included within this 5 to 1000 ppm of alkali metal cation are alkali metal cations which are part of fillers or other similar materials, such as glass or mineral fillers, if they are present during the SSP. Typically the alkali metal cation will be added as a monomeric compound to the polymerization. It may be the alkali metal salt of a carboxyl containing monomer, such as disodium terephthalate or potassium 4-hydroxybenzoate. If a hydroxycarboxylic acid is one of the monomers, an alkali metal salt of that compound is a preferred way of adding the alkali metal cation. A particularly preferred alkali metal salt is an alkali metal 4-hydroxybenzoate, especially particularly potassium 4-hydroxybenzoate. Other alkali metal salts may be used, such as lithium acetate. While inorganic salts may be used, they may not be as effective as organic salts such as alkali metal carboxylates.

Preferably the alkali metal cation is lithium, sodium or potassium and more preferably potassium cation. The amount of alkali metal cation is based on the amount of alkali metal cation itself, not the compound in which it is added. The amount of alkali metal cation in ppm is based on the total amount of LCP in the process. At least 5 ppm, preferably 10 ppm of the alkali metal cation is present. The maximum amount of alkali metal cation is about 1000 ppm, more preferably about 100 ppm, and especially preferably about 40 ppm. Any maximum and minimum preferred amounts of alkali metal cation above can be combined to form a preferred range of alkali metal cation.

The SSP is carried out at about 300° C. or more, more preferably about 320° C. or more and most preferably about 340° C. or more. If any part of the SSP is carried out at these temperatures, the process is deemed to have met the temperature requirement for the present process. For instance, if the SSP is done in 2 stages, 3 hours at 280° C. and 1 hour at 320° C., it meets the limitations of the present process.

The melting point of the “final” LCP product from the SSP has a melting point of about 380° C. or more and preferably about 400° C. or more. The melting point is taken as the peak of the melting endotherm on the second heat when measured by Differential Scanning Calorimetry according to ASTM Method D3418-82, using a heating rate of 25° C./min. By “second heat” is meant the LCP is heated from room temperature at 25° C./min to above the melting point, cooled at 25° C./min to about 200° C., then heated again at 25° C./min to above the melting point. The melting point of the second heat is taken during the second melting of the LCP.

As alluded to above, other inert ingredients may be present in the SSP step. For example fillers, reinforcing agents and/or pigments such as glass fiber, milled glass, aramid fiber, carbon black, TiO₂, and clay may be present during the SSP step.

Preferably the LCP is a polyester LCP. Also preferably the LCP is an aromatic polymer. By an “aromatic” polymer [such as polyester or poly(ester-amide)] is meant that all of the atoms in the main chain are part of an aromatic ring, or functional groups connecting those rings such as ester or amide. The aromatic rings may be substituted with other groups such as alkyl groups.

A preferred aromatic polyester LCP has repeat units of the formula

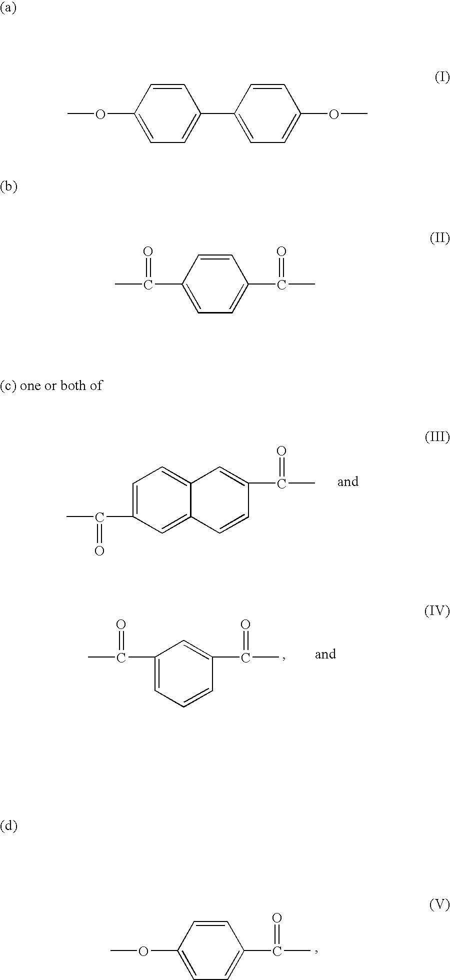

wherein per 100 molar parts of (I), (II) is 85-98 molar parts, (III)+(IV) is 2-15 molar parts, and (V) is 100 to 225 molar parts, provided that the molar ratio of (I)/(II)+(III) is about 0.90 to about 1.10. In these polymers it is preferred that only one of (III) or (IV) is present, and it is also preferred that (III) is present. (I) is derived from 4,4′-biphenol, (II) is derived from terephthalic acid, (III) is derived from 2,6-napthtalenedicarboxylic acid, (IV) is derived from isophthalic acid, and (V) is derived from 4-hydroxybenzoic acid, or one or more of their respective reactive derivatives.

Surprisingly, when the alkali metal cation is present, the color of the resulting LCP after the SSP step is usually lighter than when no alkali metal cation is added to the polymer(ization). This is compared to similar LCPs undergoing the same SSP process in both temperature, and time at temperature, during the SSP part of the process. Also surprising is that when an alkali metal cation is present, the melting point of the polymer is often higher. The LCPs produced are useful as molding resins and films, especially where high temperature resistance is required. The LCPs may be formed into shaped parts by melt forming, for example using an injection molding machine, or a single screw, twin screw, or ram extruder.

Melt viscosity is a relative measure of molecular weight and to some extent molecular weight distribution, and the higher the viscosity the higher the molecular weight if the molecular weight distributions are similar. In the Examples, melt viscosity was determined on a Kayeness rheometer (Kayeness, Inc., RD#3, Box 30, E. Main St., Honeybrook, Pa. 19344 U.S.A.). Generally, the Kayeness rheometer can readily and routinely measure melt viscosities down to about 50 Pa˜s at shear rates of 1000 sec⁻¹. The die hole diameter was 0.762 mm and the die length was 15.240 mm. The material was charged to the barrel and preheated for 6 min prior to determining the viscosities. The reported MV is the average of 7 data points taken over a period of approximately 3 min. Measurements were done at 440° C. at a shear rate of 1000 sec⁻¹, and MVs are given in Pa˜s.

Polymer color was judged visually by observing the color of polymer powder. Polymer melting points were measured as described above.

In the Examples the following abbreviations are used:

AA—acetic anhydride

BP—4,4′-biphenol

HBA—4-hydroxybenzoic acid

I—isophthalic acid

KHBA—potassium 4-hydroxybenzoate

MV—melt viscosity

N—2,6-naphthtalenedicarboxylic acid

SSP—solid state polymerization

T—terephthalic acid

Tm—polymer melting point

### EXAMPLES 1-6 AND COMPARATIVE EXAMPLES A-C

Monomers and acetic anhydride in the molar proportions indicated in Table 1 (actual weight are given in Table 2) were weighed out into a 3 L resin kettle fitted with a ground glass top and agitator. A Vigreaux column was connected to the ground glass top and the top of the column was fitted with a reflux splitter, and condenser. After the reactants were charged, the apparatus was connected as described, a nitrogen gas flush was started, and a liquid metal bath heated to 160° C. was raised into position to heat approximately 75% of the lower portion of the kettle. At this time, the reflux splitter was adjusted so that 100% of the condensed vapors were returned to the kettle. The process was operated with agitation and 100% reflux for 30 min. Then, the splitter was partially opened until an estimated 75% of the condensed material was returned to the kettle and 25% was removed to a product receiver. Next, the temperature of the metal bath was raised from 160° C. to 335° C. over a period of approximately 3 hours (h). The pressure was maintained at one atmosphere throughout. After the temperature reached 335° C., the pressure was maintained at one atmosphere for (Comparative) Examples A-B and 1-4 until the stirring motor reached maximum torque. Then, the nitrogen flush was terminated, the agitator was stopped, and the kettle was opened and the product was removed from the kettle as a solid.

In the case of the polymers of Examples 5 and 6 and Comparative Example C, the Vigreaux, splitter, and condenser were removed after the metal bath temperature reached 335° C. Then a condenser connected to a product receiver which was a round bottom flask with vacuum take-off were fitted to the kettle top. The pressure in the kettle was lowered to 84 kPa (absolute) and agitation was continued until the maximum torque of the stirring motor had been reached. Next, the nitrogen flush was terminated, the agitator was stopped, and the kettle was opened and the product was removed from the kettle as a solid.

Following isolation of the solid materials (low molecular weight LCPs), each of the materials was placed in trays in a circulating gas oven for solid state polymerization to final high molecular weight. Nitrogen was used as the gas in order to exclude air from the oven. The temperature of the oven was controlled as follows. Heated as rapidly as possible to 270° C., held for 1 h, then heated as rapidly as possible to 310° C. and held for 1 h. Finally, heated to a final temperature (320° C. or 340° C.) and held for several hours (see Table 1), followed by cooling to room temperature.

TABLE 1

| | | | | | | | SSP Final | | | | |
|---|---|---|---|---|---|---|---|---|---|---|---|
| | | | | | | | Conditions | | | | |
| Ex> | BP | T | N | I | HBA | PPM K⁺ | ° C. | Time, h | Tm, ° C. | MV | Color |
| A | 100 | 97 | 3 | 0 | 150 | 0 | 340 | 4 | 424 | 73 | Dark tan |
| 1 | 100 | 97 | 3 | 0 | 150 | 15 | 340 | 4 | 424 | 132 | Tan |
| 2 | 100 | 97 | 3 | 0 | 150 | 25 | 340 | 4 | 432 | 201 | Light tan |
| B | 100 | 97 | 3 | 0 | 150 | 0 | 320 | 16 | 425 | 69 | Dark tan |
| 3 | 100 | 97 | 3 | 0 | 150 | 15 | 320 | 16 | 430 | 96 | Tan |
| 4 | 100 | 97 | 3 | 0 | 150 | 25 | 320 | 16 | 431 | 88 | Light tan |
| C | 100 | 95 | 5 | 0 | 200 | 0 | 320 | 8 | 395 | 53 | Dark tan |
| 5 | 100 | 95 | 0 | 5 | 200 | 15 | 320 | 8 | 401 | 112 | Tan |
| 6 | 100 | 95 | 0 | 5 | 200 | 25 | 320 | 8 | 408 | 119 | Light tan |

TABLE 2

| Ex. | BP, g | T, g | N, g | HBA, g | AA, g | KHBA, g |
|---|---|---|---|---|---|---|
| A | 317.8 | 275.1 | 11.1 | 353.6 | 628.2 | 0.000 |
| 1 | 317.8 | 275.1 | 11.1 | 353.6 | 628.2 | 0.056 |
| 2 | 317.8 | 275.1 | 11.1 | 353.6 | 628.2 | 0.096 |
| B | 317.8 | 275.1 | 11.1 | 353.6 | 628.2 | 0.000 |
| 3 | 317.8 | 275.1 | 11.1 | 353.6 | 628.2 | 0.056 |
| 4 | 317.8 | 275.1 | 11.1 | 353.6 | 628.2 | 0.096 |
| C | 283.1 | 240.0 | 16.4 | 420.1 | 639.5 | 0.000 |
| 5 | 284.4 | 241.1 | 12.7 | 421.9 | 624.4 | 0.056 |
| 6 | 284.4 | 241.1 | 12.7 | 421.9 | 624.4 | 0.056 |

What is claimed is:

1. A process for the production of a polyester or poly(ester-amide) liquid crystalline polymer, comprising a step of increasing the molecular weight of said liquid crystalline polymer by solid state polymerizing of said liquid crystalline polymer at a temperature of about 300° C. or more, wherein the liquid crystalline polymer, after said solid state polymerizing, has a melting point of about 380° C. or more, wherein the improvement comprises, about 5 to about 1000 ppm of an alkali metal cation being present in said liquid crystalline polymer during said solid state polymerizing.

2. The process as recited in claim 1 wherein said alkali metal cation is lithium, sodium or potassium.

3. The process as recited in claim 1 wherein said alkali metal cation is potassium.

4. The process as recited in claim 1 wherein about 10 ppm to about 40 ppm of said alkali metal cation is present.

5. The process as recited in claim 1 wherein said alkali metal cation is added as an alkali metal carboxylate.

6. The process as recited in claim 1 wherein said alkali metal cation is added as an alkali metal 4-hydroxybenzoate.

7. The process as recited in claim 3 wherein said alkali metal cation is added as potassium 4-hydroxybenzoate.

8. The process as recited in claim 1 wherein said solid state polymerizing is carried out at about 340° C. or more.

9. The process as recited in claim 1 wherein said melting point is about 400° C. or more.

10. The process as recited in claim 1 wherein said liquid crystalline polymer has repeat units of the formula 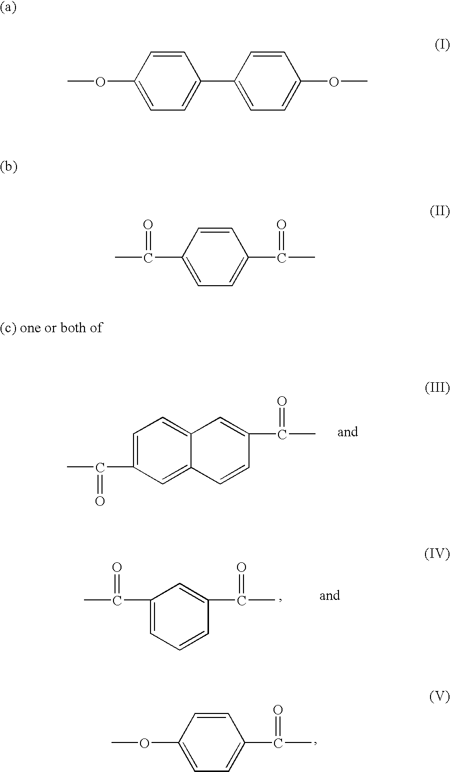
wherein per 100 molar parts of (I), (II) is 85-98 molar parts, (III)+(IV) is 2-15 molar parts, and (V) is 100 to 225 molar parts, provided that the molar ratio of (I)/(II)+(III) is about 0.90 to about 1.10.

11. The process as recited in claim 1 wherein said liquid crystalline polymer is a polyester.

12. The process as recited in claim 1 wherein said liquid crystalline polymer is an aromatic polymer.
